(19) United States
(12) Patent Application Publication
(10) Pub. No.: US 2006/0229423 A1
(43) Pub. Date: Oct. 12, 2006

(54) Process for the production of monodisperse and narrow disperse monofunctional silicones

(76) Inventors: James P. Parakka, San Bruno, CA (US); Yuan Tian, Alameda, CA (US); Robert S. Ward, Lafayette, CA (US); Wang Shanger, Fairfield, CA (US)

Correspondence Address: PHILIP S. JOHNSON;JOHNSON & JOHNSON, ONE JOHNSON & JOHNSON PLAZA, NEW BRUNSWICK, NJ, 08933-7003, US

(21) Appl. No.: 11/377,822

(22) Filed: Mar. 16, 2006

Related U.S. Application Data
(60) Provisional application No. 60/662,556, filed on Mar. 17, 2005.
(60) Provisional application No. 60/682,410, filed on May 19, 2005.

(51) Int. Cl. C08G 77/06

(52) U.S. Cl. 528/37; 528/31; 528/25; 528/14; 528/34

(57) ABSTRACT

Synthesis and purification of mono and narrow disperse monofunctional polydimethylsiloxane methacrylate derivatives with different molecular weights are disclosed.

This application claims priority under 35 USC §119(e) to U.S. Provisional Applications Nos. 60/662,556 and 60/682,410, which were filed respectively on 17 Mar. 2005 and 19 May 2005. The entire contents of each of Ser. No. 60/662,556 and Ser. No. 60/682,410 is hereby expressly incorporated by reference into the present application.

### FIELD AND BACKGROUND OF THE INVENTION

The present application relates to methods for the synthesis and purification of monodisperse and narrow disperse polymeric compositions of matter that comprise monofunctional polydimethylsiloxane derivatives (herein referred to as mPDMS). The mPDMS polymers of this invention are of use in biomaterial and other applications. The mPDMS polymers of this invention are particularly useful in the manufacture of contact lenses.

Methods for producing mPDMS polymers having higher molecular weights with a greater number of siloxane units have used anionic polymerization techniques and solvents such as tetrahydrofuran (THF), and mixtures of cyclohexane and benzene with THF.

### SUMMARY OF THE INVENTION

This invention provides a general method for the synthesis and purification of free radical reactive, substituted and unsubstituted alkyl-terminated polydimethylsiloxane compositions for both monodisperse low molecular weight oligomers and higher molecular weight polymers with polydispersities approaching 1. Specifically, in one embodiment, the present invention relates to a method comprising the steps of:

(a) reacting, in at least one non-polar solvent, hexamethylcyclotrisiloxane with a molar excess of or a salt of trialkylsilanol or at least one functionalized or unfunctionalized organometallic compound, such as an alkyl lithium compound of the formula RLi wherein R is

(a) reacting, in at least one non-polar solvent, hexamethylcyclotrisiloxane with a molar excess of or a salt of trialkylsilanol or at least one functionalized or unfunctionalized organometallic compound, such as an alkyl lithium compound of the formula RLi wherein R is an alkyl group of 1-8 carbon atoms to form a silanolate anion having mono or low dispersity. In other embodiments the silanolate anion may be further reacted with a molar excess of a chlorosilane compound of formula I:
Cl—Si—(CH₃)₂—R¹

wherein R¹ is selected from H, C1 to C8 alkyl or substituted C1 to C8 alkyl, wherein said substituents include aprotic subtstituents, such as a protected hydroxyl group, free radical reactive groups and combinations thereof. The resulting silane terminated polydimethylsilxone compounds may be further reacted with (a) substituted or unsubstituted allyl alkyl(meth)acrylates to form substituted or unsubstituted alkyl terminated polydimethylsiloxanes, or (b) substituted epoxides, which then undergo a ring opening reaction to form substituted or unsubstituted alkyl terminated polydimethylsiloxanes.

### DETAILED DISCLOSURE OF THE INVENTION

Methods for the production of mPDMS derivatives are described herein, including “monodisperse” and “narrow disperse” free radical reactive, substituted or unsubstituted alkyl-terminated polydimethylsiloxanes, such as mono and narrow disperse hydroxy mPDMS propylglycerol(meth)acrylate compositions and mPDMS propyl(meth)acrylate compositions. The abbreviation “mPDMS” refers to monofunctional polydimethylsiloxanes. The term “monodisperse” refers to a siloxane polymer product in which at least about 98% of the polymer present has the same molecular weight. The terminology “narrow disperse” refers to a siloxane polymer product in which at least about 85%, at least about 90% of said siloxane polymer is the desired molecular weight. As used herein (meth)acrylate, includes both acrylates and methacrylates.

In the first step of the present method hexamethylcyclotrisiloxane (D₃) is reacted with a either functionalized or unfunctionalized organometallic compounds or a salt of frialkylsilanol such as those having the formula MOSiR₂R₃R₄, wherein R₂-R₄ are independently selected from alkyl groups having 1-8 carbon atoms, and M is an species capable of bearing a positive charge, such as metals and tetra alkyl ammonium ions. Suitable examples a salt of trialkylsilanol include tetrabutylammonium salt of trimethylsilanol. Suitable examples of functionalized or unfunctionalized organometallic compounds include alkyl lithium compound of the formula RLi wherein R is an alkyl group of 1-8 carbon atoms in the presence of at least one non-polar solvent. Suitable non-polar solvents include hydrocarbon liquids which do not contain an abstractable proton. Examples of non-polar solvents include pentane, cyclohexane, hexane, heptane, benzene, toluene, higher non-polar hydrocarbons, mixtures thereof and the like. In one embodiment the non-polar solvents include pentane, cyclohexane, hexane, mixtures thereof and the like. The use of non-polar solvents in the initiation stage of the ring opening reaction produces mono or narrow dispersed silanolate anion.

Hexamethylcylcotrisiloxane is commercially available. In one embodiment the alkyl lithium compound is selected from nbutyl lithium or sec-butyl lithium.

The hexamethylcyclotrisiloxane and alkyl lithium compound are used in a stiochiometric amount based upon the number of dimethylsiloxane repeating units which are desired in the final mPDMS derivative. So for example, if an mPDMS derivative having one dimethylsiloxane repeating unit is desired, the mole ratio of alkyl lithium compound to hexamethylcyclotrisiloxane used is about 1:1.1 to about 1:1.5. As the desired molecular weight of the product increases, the ratio of alkyl lithium compound to hexamethylcyclotrisiloxane decreases. Other molar ratios may be calculated by those of skill in the art using the teachings of the present invention. The reaction is conducted at temperatures between about 5 to about 60° C., and in some embodiments from about 5 to about 30° C. The reaction is conducted for about 1 to 4 hours. Ambient pressure may be used.

Where higher molecular weight mPDMS derivatives are desired, a polar chain propagating solvent, such as THF, diethyl ether, dioxane, DMSO, DMF, hexamethylphosphortriamide, mixtures thereof and the like is added after the initial reaction is complete. In one embodiment, THF, dioxane, DMSO or mixtures thereof is used as the polar chain propagating solvent, and in another embodiment the polar chain propagating solvent comprises THF. The polar chain propagating solvent is added under controlled conditions and the reaction is allowed to proceed for a period from about 2 to about 24 hours at a temperature between about 5 and 60° C., and in some embodiments from about 5 to about 30° C. The conversion of the hexamethylcyclotrisiloxane is measured via gas chromatographic analysis.

The silanolate anion is then reacted with a chlorosilane compound of formula I:
Cl—Si—(CH₃)₂—R¹

wherein R¹ is selected from H, C1 to C8 alkyl or substituted C1 to C8 alkyl, wherein said substituents include aprotic subtstituents, such as a protected hydroxyl group, free radical reactive groups and combinations thereof. As used herein, free radical reactive group includes (meth)acrylates, styryls, vinyls, vinyl ethers, C₁₋₆alkylacrylates, acrylamides, C₁₋₆alkylacrylamides, N-vinyllactams, N-vinylamides, C₂₋₆alkenyls, C₂₋₁₂alkenylphenyls, C₂₋₁₂alkenylnaphthyls, or C₂₋₆alkenylphenylC₁₋₆alkyls. In one embodiment the free radical reactive groups include (meth)acrylates, acryloxys, (meth)acrylamides, the like and mixtures thereof. In one embodiment the free radical reactive group is a methacrylate or acrylate group.

An excess of the chlorosilane is used. While any molar ratio of chlorosilane compound to silanolate anion may be used, ratios from about 1.1:1 to about 5 to 1, and in some embodiments from about 1.1:1 to about 2 to 1 are used for reasons of economy. The reaction of the chlorosilane with the silanolate anion is exothermic. Accordingly, the reaction temperature is maintained by known means, such as controlled addition of the chlorosilane or decreasing the temperature of the reaction mixture prior to chlorosilane addition. This termination reaction may be conducted at temperatures below about 70° C., and in some embodiments at temperatures between about 0° C. and 70° C. for times from about 15 minutes to about 4 hours.

When R₁ is other than H, the termination reaction produces the desired narrow or monodisperse substituted or unsubstituted alkyl-mPDMS derivatives.

When the chlorosilane is dimethylchlorosilane the termination reaction produces a silane terminated polydimethyl siloxane. The silane terminated PDMS can be purified before further reaction or may be used directly. Impurities may be removed by numerous methods, including, filtration of LiCl; evaporation of excess chlorodimethylsilane; washing of the residual material with aqueous base (dilute sodium bicarbonate) to remove residual HCl followed by aqueous wash; and drying (anhydrous sodium sulfate) and distillation (using falling film or wiped film evaporators or other distillation methods known to those skilled in the art) to remove water and any residual traces of D₃ or higher cyclics. When purification of the silane terminated PDMS is desired, any of a number of methods can be used, such as distillation, so long as the conditions selected, such as residence time, the number of plates used, vacuum and temperature are sufficient to provide a silane terminated PDMS having at least a narrow disperse molecular weight as defined herein. Alternatively, the silane terminated PDMS may be purified by evaporation of the chlorosilane followed by aqueous extraction (using aqueous base) of the LiCl and distillation as described above.

When R¹ is hydrogen the process of the present invention further comprises a hydrosilylation step. The silane terminated PDMS may then be reacted with an allyl (meth)acrylate or a substituted epoxide via a hydrosilylation reaction, such as that disclosed in US2006/0047134, the disclosures of which is incorporated in its entirety herein by reference. The allyl(meth)acrylate is used in a molar excess of about 10 to about 100% excess.

Examples of suitable allyl(meth)acrylates include allyl(meth)acrylate, allyloxyhydroxypropyl methacrylate and allyloxyhydroxypropylacrylate. It should be appreciated that allyl glycerol(meth)acrylate exist in equilibrium as mixtures of the primary and secondary alcohol. In any reaction disclosed herein, the equilibrium mixture of allyl glycerol(meth)acrylate may be used.

Suitable substituted epoxides include monosubstituted epoxides having a terminal vinyl group. Specific examples include epoxides of formula III

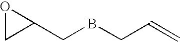

where B is a group which can hydrogen bond with another moiety or a carboxylic acid derivative. Specific examples for B include heteroatoms, including O, S, N, P, and the like, carbonyl, alkylene having 1 to 6 carbon atoms which may be unsubstituted or substituted with hydroxy, amines, amides, ethers, esters, aldehydes, ketones, aromatics, alkyl groups and combinations thereof.

In one embodiment B is O or a hydroxyl substituted alkyl group having 1-4 carbon atoms. A specific example of a substituted epoxide includes allyl glycidyl ether.

The silane terminated PDMS is reacted with the suitable allyl(meth)acrylate or substituted epoxide with a hydrosilylation catalyst. Suitable hydrosilylation catalysts include metal halides, including chlorides, bromides and iodides of chromium, cobalt, nickel, germanium, zinc, tin, mercury, copper iron, ruthenium, platinum, antimony, bismuth, selenium and tellurium. Specific examples of suitable hydrosilylation catalysts include platinum alone, catalysts composed of solid platinum on carriers such as alumina, silica and carbon black, chloroplatinic acid, complexes of chloroplatinic acid with alcohols, aldehydes and ketones, platinum-olefin complexes {for example, Pt(CH₂═CH₂)₂(PPh₃)₂Pt(CH₂═CH₂)₂Cl₂}; platinum-vinyl siloxane complexes {for example, Ptn(ViMe₂SiOSiMe₂Vi)ₘ, Pt[(MeViSiO)₄]ₘ}; platinum-phosphine complexes {for example, Pt(PPh₃)₄, Pt(PBu₃)₄}; platinum-phosphite complexes {for example, Pt[P(OPh)₃]₄, Pt[P(OBu)₃]₄} (in which formulas, Me is a methyl group, Bu is a butyl group, Vi is a vinyl group, Ph is a phenyl group and n and m are integers), dicarbonyl dichloroplatinum, platinum-hydrocarbon complexes as described in U.S. Pat. No. 3,159,601 and U.S. Pat. No. 3,159,662 and platinum-alcoholate catalysts as described in U.S. Pat. No. 3,220,972. In addition, platinum chloride-olefin complexes as described in U.S. Pat. No. 3,516,946 are useful. Examples of catalysts other than platinum compounds that can also be used include RhCl(PPh₃)₃, RhCl₃, Rh/Al₂O₃, RuCl₃, IrCl₃, FeCl₃, AlCl₃, PdCl₂≈2H₂O, NiCl₂ and TiCl₄ (Ph indicating a phenyl group). Rhodium-based catalyst such as Wilkinson's catalyst may also be used. Preferred hydrosilation catalysts include chlorides of platinum, and vinyl complexes of platinum such as Karstedt's and Ashby's catalysts and particularly useful hydrosilation catalysts include Karstedt's (Pt₂{[(CH2═CH)Me₂Si]₂O}₃) and low halogen containing platinum vinyl siloxane complexes, as described by U.S. Pat. No. 4,421,903 and U.S. Pat. No. 4,288,345 (Ashby's catalysts).

The hydrosilylation catalyst is used in suitable amounts including between about 1 and about 500 ppm, and preferably about 5 and about 100 ppm.

The reaction is conducted under mild conditions, such as temperatures between about 0 to about 100° C., preferably between about 0° and about 60° C., and more preferably from about 5 to about 40° C. It has been found that these reaction temperatures reduce by-products by an appreciable amount even if the time of reaction is increased. Pressure is not critical, and atmospheric pressure may be used. Reaction times of up to about 24 hours, preferably up to about 12 hours and more preferably between about 4 and about 12 hours may be used. It will be appreciated by those of skill in the art the temperature and reaction time are inversely proportional, and that higher reaction temperatures may allow for decreased reaction times and vice versa.

The components may be mixed neat (without solvent) or in solvents, such as aliphatic hydrocarbons, aromatic hydrocarbons, ethers, ketones, mixtures thereof and the like. Suitable examples in each class include, aromatic hydrocarbon solvents such as benzene, toluene and xylene; aliphatic hydrocarbon solvents such as pentane, hexane, octane or higher saturated hydrocarbons; ether solvents such as ethyl ether, butyl ether and tetrahydrofuran; alcohols, such as isopropanol and ethanol, and halogenated hydrocarbon solvents such as trichloroethylene and mixtures thereof. In one embodiment the hydrosilylation reaction is conducted without solvent.

If a substituted epoxide was used in the hydrosilylation reaction, the resulting alkyl epoxy—PDMS may be undergo an epoxide ring opening reaction under conditions disclosed in U.S. Ser. No. 10/862074. In this embodiment the substituted epoxide is reacted with at least one acrylic acid and at least one lithium salt of said acrylic acid. Suitable acrylic acids comprise between 1 and 4 carbon atoms. In one embodiment the acrylic acid is methacrylic acid. The reaction between the substituted epoxide and the acrylic acid may be equimolar, however, it may be advantageous to add an excess of acrylic acid. Accordingly, the acrylic acid may be used in amounts between about 1 and about 3 moles of acrylic acid per mole of the epoxide.

The lithium salts comprise lithium and at least one acrylic acid comprising between 1 and 4 carbon atoms. In one embodiment the lithium salt is the Li salt of methacrylic acid. The lithium salt is added in an amount sufficient to catalyze the reaction, and preferably in an amount up to about 0.5 equivalents, based upon the epoxide.

An inhibitor may also be included with the reactants. Any inhibitor which is capable of reducing the rate of polymerization may be used. Suitable inhibitors include sulfides, thiols, quinines, phenothiazine, sulfur, phenol and phenol derivatives, mixtures thereof and the like. Specific examples include, but are not limited to hydroquinone monomethyl ether, butylated hydroxytoluene, mixtures thereof and the like. The inhibitor may be added in an amount up to about 10,000 ppm, and preferably in an amount between about 1 and about 1,000 ppm.

Inhibitors may also be used, appropriate amounts, in any of the other process steps disclosed herein including free radical reactive compounds.

The epoxide ring opening reaction is conducted at elevated temperatures, preferably greater than about 60° C. and more preferably between about 80° C. and about 110° C. Suitable reaction times include up to about a day, in some embodiments between about 4 and about 20 hours, and in other embodiments between six hours and about 20 hours. It will be appreciated by those of skill in the art the temperature and reaction time are inversely proportional, and that higher reaction temperatures may allow for decreased reaction times and vice versa. However, in the process of the present invention it is desirable to run the reaction to or near completion (for example, greater than about 95% conversion of substituted epoxide, and preferably greater than about 98% conversion of substituted epoxide).

The above described process yields mono or narrow disperse narrow or monodisperse, substituted or unsubstituted alkyl-mPDMS derivatives. Examples of substituted or unsubstituted alkyl-mPDMS derivatives which may be produced by the process of the present invention include mono-(3-methacryloxy-2-hydroxypropyloxy)propyl terminated, mono-butyl terminated polydimethylsiloxane and monomethacryloxypropyl terminated mono-n-butyl terminated polydimethylsiloxanes. The distribution of average MW may be confirmed by gel permeation chromatography, NMR 1H and 29Si) and mass spectral (MALDI-TOFS) analysis. The resulting narrow disperse product can be further purified under controlled temperature and vacuum conditions using fractional distillation methods such as packed column or multi-plate distillation, and other methods known in the art such as chromatography known to those skilled in the art.

The present invention has been described above. In order to illustrate the invention the following exemplary reaction schemes are included. These exemplary reaction descriptions do not limit the invention. They are meant only to suggest a method of practicing the invention. Those knowledgeable in the field of synthesis of silicone compounds as well as other specialties may find other methods of practicing the invention. However, those methods are deemed to be within the scope of this invention.

Approach 1:

This approach, for the parent hydroxy-monofunctional dimethylsiloxane derivative, is depicted in Scheme 1A. 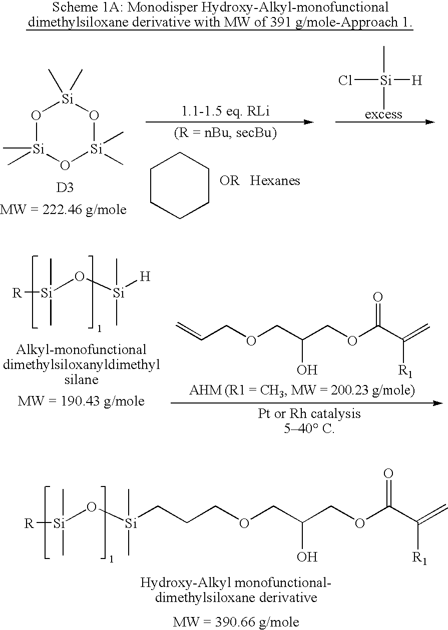
Step 1: Synthesis and Purification of mPDMS-H Derivatives

Method A: The first step is the anionic ring opening reaction involving the ring opening of commercially available D₃ using a molar excess of an alkyllithium reagent such as n-butylLi or sec-butylLi (mole ratio of BuLi:D₃ from about 1.1:1 to 2:1) in a nonpolar solvent such as cyclohexane or hexane at a temperature of between about 5 and about 60° C. for about 1 to about 4 hours) followed by termination of generated alkyldimethylsilanolate anion with an excess of chlorodimethylsilane (typically 1.1-5 times the amount of alkyllithium reagent used). The resulting reaction product can be purified by: filtration of LiCl; evaporation of excess chlorodimethylsilane; washing of the residual material with aqueous base (dilute sodium bicarbonate) to remove residual HCl followed by aqueous wash; and drying (anhydrous sodium sulfate) and distillation (using falling film or wiped film evaporators or other distillation methods known to those skilled in the art) to remove water and any residual traces of D₃ or higher cyclics. The resulting product is the n-butyl- or sec-butyl-monofunctional dimethylsiloxanyl dimethylsilane derivative with MW of 190 g/mole.

Method B: To obtain narrow disperse and monodisperse mPDMS-H compositions with MW above 190 g/mole, the reaction is conducted with calculated amounts of D₃ to the alkyllithium reagent (such as n-butylLi or sec-butylLi) in cyclohexane or hexane at temperatures of between about 5 and about 60° C. for between about 1 and about 4 hours. This is followed by a addition of a polar chain propagating aprotic solvent such as THF under controlled conditions (time between about 2 and about 24 hours and a temperature between about 5 and about 60° C.) until near complete conversion of D₃ is observed by gas chromatography analysis. The generated alkylpolydimethylsiloxonalate anion is terminated with an excess of chlorodimethylsilane.

The resulting reaction product can be purified by: filtration of LiCl; evaporation of excess chlorodimethylsilane; washing of the residual material with aqueous base (dilute sodium bicarbonate) to remove residual HCl followed by aqueous wash; and drying (anhydrous sodium sulfate) and distillation (using falling film or wiped film evaporators or other distillation methods known to those skilled in the art) to remove water and any residual traces of D₃ or higher cyclics. The above described process yields an alkyl-mPDMS-H of narrow MW distribution of average MW of ˜413 which can be confirmed by gel permeation chromatography, NMR (¹H and ²⁹Si) and mass spectral (MALDI-TOF) analysis. The resulting narrow disperse product can be further purified under controlled temperature and vacuum conditions using fractional distillation methods known to those skilled in the art to yield monodisperse n-butyl-mPDMS-H or the sec-butyl-mPDMS-H derivative. The synthesis protocol for Alkyl-Hydroxy-mPDMS composition with MW of ˜613 g/mole is depicted in Scheme 1B 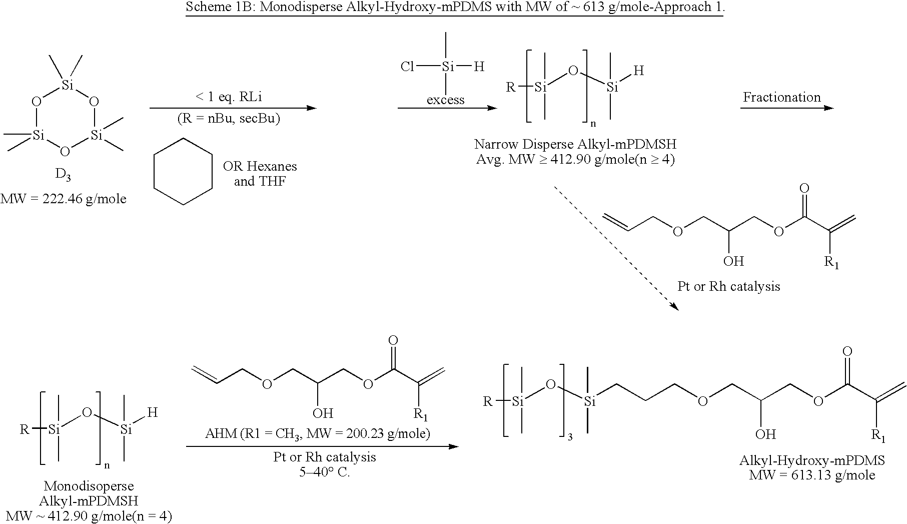
Step 2: Synthesis and Purification of Hydroxy-mPDMS via Hydrosilylation

The purified narrow disperse or monodisperse hydride-terminated product obtained from step 1 (Method A or Method B) is reacted with a molar excess of allyloxy hydroxypropyl methacrylate (AHM) or allyloxy hydroxypropyl acrylate (AHA) in the presence of a hydrosilylation catalyst. Suitable catalysts include rhodium-based catalyst such as Wilkinson's catalyst and platinum-based catalysts such as Karstedt catalyst, Pt(0)tetramethyltetravinylcyclotetrasiloxanes, chloroplatinic acid, Pt/C, and PtO₂. The reaction may be conducted at a temperature between about 5 and about 40° C.) under an atmosphere of dry compressed air, nitrogen, or argon and for a duration until almost complete consumption of the starting mPDMS-H is detected (from FTIR analysis). At the end of the reaction, the mixture is deactivated using a small amount of diethylethylenediamine, typically from about 10 to about 100 times the moles of active Pt catalyst. The “as-synthesized” reaction product is then washed several times with ethylene glycol to remove unreacted AHM or AHA (typically until <0.1% of AHM or AHA is left behind in the product). To remove residual unreacted mPDMS-H and any high molecular weight/polymeric byproducts, the product after ethylene glycol wash may be diluted with methanol (1:3-1:5 volume ratio). The resultant turbid solution upon settling has two phases. The process may be repeated until mPDMS-H is not detected in the washed product by FTIR. The above washing/extraction process can be accelerated using a batch centrifugal separator, a continuous contactor unit, or other separation equipment known to those skilled in the art. Inhibition of the product obtained after liquid-liquid extraction by MEHQ or BHT (typically ˜50-100 ppm) followed by distillation using wiped film or a falling film evaporator (until almost all ethylene glycol is removed) yields a hydroxy-mPDMS derivative of high purity.

Thus monodisperse alkyl-hydroxy-mPDMS derivatives with different MW's can be obtained using AHM and suitable Alkyl-mPDMS-H, examples of product with MW of 391 g/mole and 613 g/mole are outlined in Scheme 1A and Scheme 1B, respectively. A similar method of synthesis and purification may be employed to prepare trimethylsilyl-hydroxy-mPDMS derivatives, by using a lithium or tetrabutylammonium salt of trimethylsilanolate as illustrated in Scheme 2. This general hydrosilylation synthesis and purification procedure is applicable toward the synthesis of higher MW alkyl-hydroxy-mPDMS analogs using higher molecular weight alkyl-mPDMS-hydride starting materials. The general synthesis and purification method disclosed above can be used for the preparation of alkyl-hydroxy-mPDMS compositions of different molecular weights with polydisperse molecular weight distribution using appropriate polydisperse alkyl-PDMS-H starting materials. 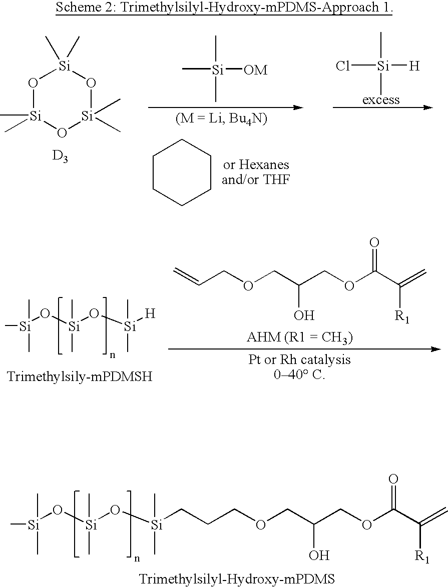
Approach 2:

The second approach for the synthesis of alkyl-hydroxy-mPDMS in accordance with the present invention involves a three-step sequence. The strategy for this approach is outlined in Scheme 3 for a final product MW of ˜613 g/mole. 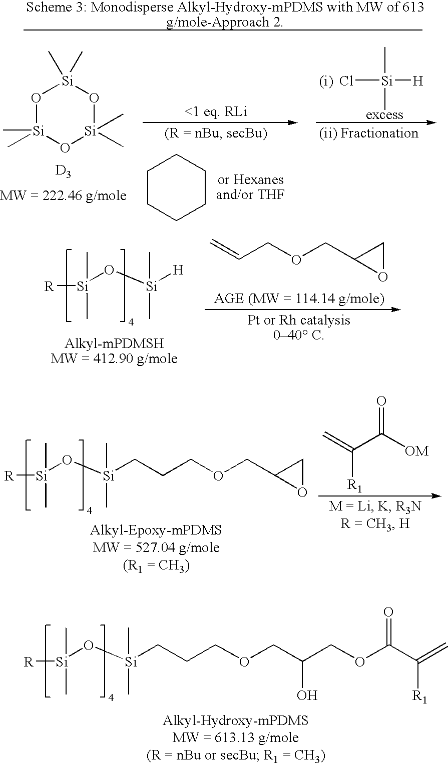
Step 1: Synthesis and Purification of Alkyl-mPDMS-H Derivatives

The first synthesis step in Approach 2 follows the same anionic ring opening protocol described in step 1 (Method B) of Approach 1.

Step 2: Synthesis/Purification of Alkyl-Epoxy-mPDMS Derivative via Hydrosilylation

The hydrosilylation reaction of commercially available allyl glycidyl ether with narrow disperse or monodisperse alkyl-mPDMS-H, obtained from Step 1, forms the desired intermediate alkyl-epoxy-mPDMS derivative in good yields. The resulting alkyl-epoxy-mPDMS derivative may be distilled using a falling film evaporator or wiped film evaporator under high vacuum and at moderate/high temperatures to yield very high purity epoxy derivative.

Step 3: Synthesis/Purification of Alkyl-Hydroxy-mPDMS via Oxirane Ring Opening Reaction

Ring opening of the purified alkyl-epoxy-mPDMS using a methacrylate or an acrylate salt yields the corresponding alkyl-hydroxy-mPDMS derivatives in good purity after purification procedures known to those skilled in the art.

Approach 3:

The two-step approach is depicted in Scheme 4. 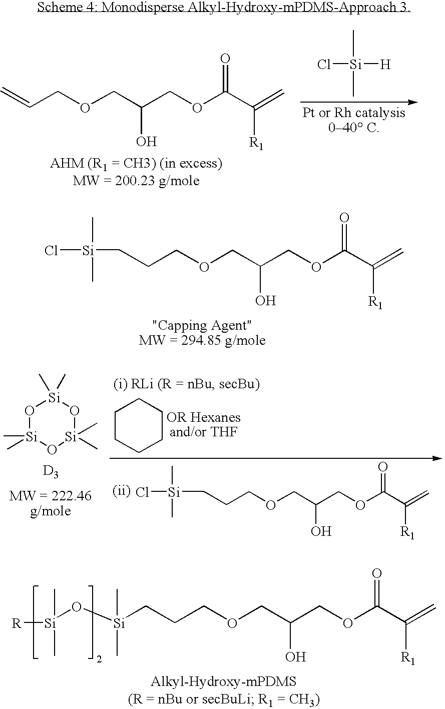
Step 1: Synthesis of “Capping Agent” via Hydrosilylation

The first step is the hydrosilylation reaction between AHM or AHA with commercially available chlorodimethylsilane. Purification of the resulting product under inert/dry conditions and by distillation techniques known to those skilled in the art provides high purity product that is an effective chain terminating agent or “capping agent” for the next reaction step.

Step 2: Synthesis of Alkyl-Hydroxy-mPDMS by Ring Opening of D₃

The second step is the controlled ring opening of hexamethylcyclotrisiloxane (D₃) by procedures described above in step1 of Approach 1, followed by terminating the siloxanolate anion with the “capping agent”. Purification of the ‘as-synthesized’ reaction product by extraction and distillation methods yields high purity alkyl-hydroxy-mPDMS.

The disclosed methodologies covers novel synthesis and purification of hydroxy-monofunctional PDMS propylglycerol(meth)acrylate derivatives of the type described herein with different molecular weights and having different molecular distribution from monodisperse to narrow disperse to polydisperse product.

Novel Monodisperse and Narrow Disperse mPDMSpropyl Methacrylate Compositions

Two examples of approaches to obtaining novel methacrylate-monofunctional polydimethylsiloxane derivatives with monodisperse and narrow MW distribution are outlined below:

Approach 1:

The reaction scheme for synthesis of novel monodisperse mPDMS derivatives is outlined in Scheme 5. The ring opening reaction of D₃ under controlled anionic polymerization in nonpolar and/or polar aprotic solvents followed by reaction of the in situ generated siloxanolate anion with commercially available chlorodimethylsilyl-propyl methacrylate is capable of yielding narrow disperse and monodisperse mPDMS derivatives bearing terminal methacrylate functionality. 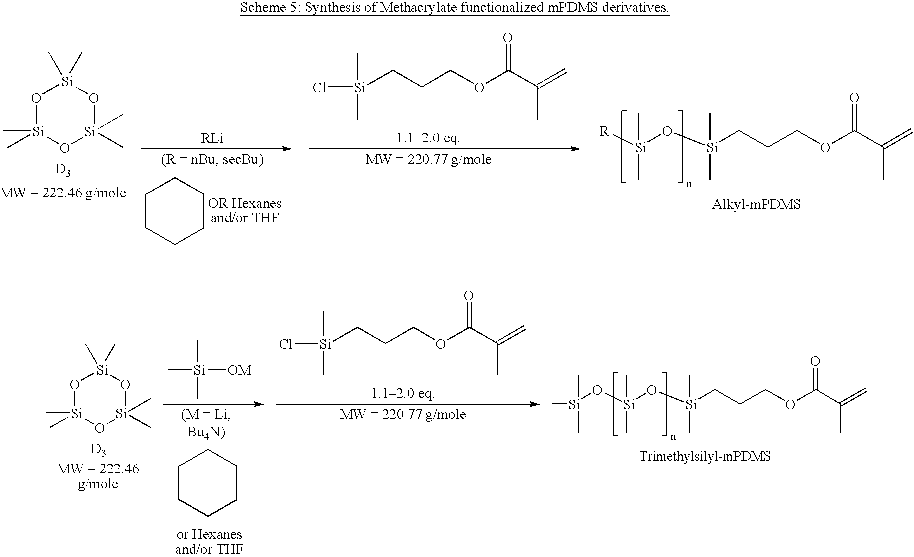
Scheme 5: Synthesis of Methacrylate Functionalized mPDMS Derivatives.
Approach 2:

The synthesis protocol employs the hydrosilylation reaction between monodisperse or narrow disperse Alkyl-PDMS-H and commercially available allyl methacrylate under conditions described for the synthesis of alkylhydroxy-mPDMS. The synthesis steps to obtain final product with MW of 982 g/mole and with narrow polydispersity are illustrated in Scheme 6.

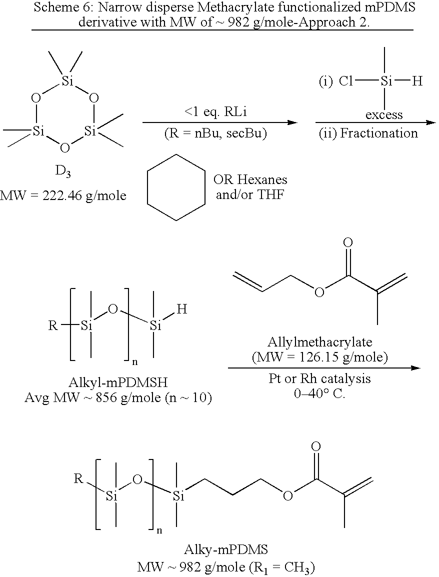

What is claimed is:

1. A method for the preparation of a monodisperse or narrow disperse mono-functional polydimethylsiloxane composition, which method comprises the steps of:
reacting hexamethylcyclotrisiloxane with an alkyl lithium compound of the formula RLi wherein R is an alkyl group of 1-8 carbon atoms.

2. The method of claim 1 for the preparation of a monodisperse or narrow disperse hydroxy-alkyl-monofunctional dimethylsiloxane composition that comprises the steps of:
reacting hexamethylcyclotrisiloxane with a molar excess of an alkyl lithium compound of the formula RLi wherein R is an alkyl group of 1-8 carbon atoms in a nonpolar solvent to form an silanolate anion;
reacting said silanolate anion with a molar excess of chlorodimethylsilane to form a monodisperse alkyl-monofunctional dimethylsiloxane having an SiH endgroup; and
reacting said alkyl-monofunctional dimethylsiloxane having an SiH endgroup with a molar excess of allyloxy hydroxypropyl(meth)acrylate in the presence of a platinum or rhodium catalyst to form a monodisperse alkyl-terminated polydimethylsiloxane having a (meth)acrylate hydroxypropyl ether endgroup.

3. The method of claim 1 for the preparation of a monodisperse or narrow disperse hydroxy-functional polydimethylsiloxane composition that comprises the steps of:
reacting hexamethylcyclotrisiloxane with a calculated amount of an alkyl lithium compound of the formula RLi wherein R is an alkyl group of 1-8 carbon atoms in nonpolar and polar aprotic solvents to form an alkyltetramethyl-tetrasiloxanolate anion;
reacting said alkyltetramethyl-tetrasiloxanolate anion with a molar excess of chlorodimethylsilane to form a narrow disperse alkyl-terminated polydimethylsiloxane having an SiH endgroup;
fractionating the narrow disperse alkyl-terminated polydimethylsiloxane having an SiH endgroup to form a monodisperse or narrow disperse alkyl-terminated polydimethylsiloxane having a SiH end group; and
reacting said monodisperse or narrow disperse alkyl-terminated polydimethylsiloxane having an SiH endgroup with a molar excess of allyl glycidyl ether in the presence of a platinum or rhodium catalyst to form a monodisperse or narrow disperse alkyl-epoxy-mPDMS derivative; and
reacting said alkyl-epoxy-mPDMS derivative with a (meth)acrylate salt to form a monodisperse or narrow disperse alkyl-terminated polydimethylsiloxane having a (meth)acrylate hydroxypropyl ether endgroup.

4. The method of claim 1 for the preparation of a monodisperse or narrow disperse polydimethylsiloxane with terminal methacrylate functionality that comprises the steps of:
reacting hexamethylcyclotrisiloxane with calculated amount of alkyl lithium compound of the formula RLi wherein R is an alkyl group of 1-8 carbon atoms in a nonpolar solvent to form an siloxanolate anion; and
reacting said siloxanolate anion with a molar excess of chlorodimethylsilylpropyl methacrylate to form a narrow disperse alkyl-terminated polydimethylsiloxane having a methacryloxypropyl endgroup;
fractionating the narrow disperse alkyl-terminated polydimethylsiloxane having a methacryloxypropyl endgroup to form the monodisperse alkyl-terminated polydimethylsiloxane having a methacryloxypropyl endgroup.

5. The method of claim 1 for the preparation of a monodisperse or narrow disperse hydroxy-functional polydimethylsiloxane composition that comprises the steps of:
reacting allyloxy hydroxypropyl(meth)acrylate with chlorodimethylsilane in the presence of a platinum or rhodium catalyst to form a hydroxypropyl(meth)acrylate having a chlorosilyl chain terminating endgroup; and
reacting, in nonpolar and/or polar aprotic solvents, hexamethylcyclotrisiloxane with a calculated amount of an alkyl lithium compound of the formula RLi wherein R is an alkyl group of 1-8 carbon atoms and with said hydroxypropyl(meth)acrylate having a chlorosilyl chain terminating endgroup to form a monodisperse or narrow disperse alkyl-terminated polydimethylsiloxane having a (meth)acrylate hydroxypropyl ether endgroup.

6. A method for the preparation of a monodisperse or narrow disperse mono-functional polydimethylsiloxane composition, which method comprises the steps of:
reacting hexamethylcyclotrisiloxane with an alkyl lithium compound of the formula RLi wherein R is an alkyl group of 1-8 carbon atoms to form a siloxanolate anion; and
reacting said siloxanolate anion with a molar excess of chlorodimethylsilane.

7. The method of claim 6 for the preparation of a monodisperse or narrow disperse polydimethylsiloxane with terminal methacrylate functionality that comprises the steps of:
reacting hexamethylcyclotrisiloxane with a calculated amount of alkyl lithium compound of the formula RLi wherein R is an alkyl group of 1-8 carbon atoms in nonpolar and polar aprotic solvents to form an siloxanolate anion;
reacting said siloxanolate anion with a molar excess of chlorodimethylsilane to form a narrow disperse alkyl-terminated polydimethylsiloxane having a SiH endgroup;
fractionation of the narrow disperse alkyl-terminated polydimethylsiloxane having an SiH endgroup to form the monodisperse alkyl-terminated polydimethylsiloxane having a SiH end group; and
reacting said narrow disperse alkyl-terminated polydimethylsiloxane having a SiH endgroup or the monodisperse alkyl-terminated polydimethylsiloxane having an SiH endgroup with a molar excess of allyl (meth)acrylate in the presence of a platinum or rhodium catalyst to form a narrow disperse or monodisperse terminated-terminated polydimethylsiloxane having a methacryloxypropyl endgroup.

8. The method of claim 6 for the preparation of a higher molecular weight narrow disperse or monodisperse hydroxy-functional polydimethylsiloxane composition that comprises the steps of:
reacting hexamethylcyclotrisiloxane with a calculated amount of alkyl lithium compound of the formula RLi wherein R is an alkyl group of 1-8 carbon atoms in a mixture of nonpolar and polar solvents to form an siloxanolate anion;
reacting said siloxanolate anion with a molar excess of chlorodimethylsilane to form a narrow disperse alkyl-terminated polydimethylsiloxane having a SiH endgroup;
fractionation of the narrow disperse alkyl-terminated polydimethylsiloxane having an SiH endgroup to form the monodisperse alkyl-terminated polydimethylsiloxane having a SiH end group; and
reacting said alkyl-terminated polydimethylsiloxane having an SiH endgroup with a molar excess of allyloxy hydroxypropyl(meth)acrylate in the presence of a platinum or rhodium catalyst to form a narrow disperse or monodisperse alkyl-terminated polydimethylsiloxane having a (meth)acrylate hydroxypropyl ether endgroup.

9. A method for the preparation of a monodisperse or narrow disperse mono-functional polydimethylsiloxane composition, which method comprises the steps of:
reacting hexamethylcyclotrisiloxane with a salt of trialkylsilanol.

10. The method of claim 9 for the preparation of a monodisperse or narrow disperse hydroxy-functional polydimethylsiloxane composition that comprises the steps of:
reacting in a nonpolar solvent and/or polar aprotic solvents, hexamethylcyclotrisiloxane with a calculated amount of a trimethylsilanolate, wherein the cation of the trimethylsilanolate is a lithium ion or a quaternary ammonium ion of the formula R₄N⁺ in which R is an alkyl group of 1-8 carbon atoms, with a molar excess of chlorodimethylsilane to form a trimethylsilyl-terminated polydimethylsiloxane having an SiH endgroup; and
reacting said trimethylsilyl-terminated polydimethylsiloxane having an SiH endgroup with a molar excess of allyloxy hydroxypropyl(meth)acrylate in the presence of a platinum or rhodium catalyst to form an alkyl-terminated polydimethylsiloxane having a (meth)acrylate hydroxypropyl ether endgroup.

11. The method of claim 9 for the preparation of a monodisperse or narrow disperse polydimethylsiloxane with terminal methacrylate functionality that comprises the steps of:
reacting hexamethylcyclotrisiloxane with calculated amounts of a lithium or tetrabutylammonium salt of trimethylsilanolate in nonpolar and/or polar aprotic solvents to form a siloxanolate anion; and
reacting said siloxanolate anion with a molar excess of chlorodimethylsilylpropyl methacrylate in the presence of a hydrosilylation catalyst to form a monodisperse or narrow disperse trimethylsilyl-terminated polydimethylsiloxane having a methacryloxypropyl endgroup.

12. A method comprising the steps of:
(a) reacting, in at least one non-polar solvent, hexamethylcyclotrisiloxane with a molar excess of a salt of trialkylsilanol or a functionalized or unfunctionalized organometallic compound to form an silanolate anion;
(b) reacting said silanolate anion with a molar excess of a chlorosilane compound of formula I:
Cl—Si—(CH₃)₂—R¹
wherein R¹ is selected from H, C1 to C8 alkyl or substituted C1 to C8 alkyl, wherein said substituents include aprotic subtstituents, such as a protected hydroxyl group, free radical reactive groups and combinations thereof.

13. The method of claim 12 wherein said non-polar solvent is selected from the group consisting of pentane, cyclohexane, hexane, heptane, benzene, toluene, higher non-polar hydrocarbons and mixtures thereof.

14. The method of claim 12 wherein said non-polar solvent is selected from the group consisting of pentane, cyclohexane, hexane, mixtures thereof and the like.

15. The method of claim 12 wherein said non-polar solvent comprises cyclohexane.

16. The method of claim 12 wherein said reacting step (a) is conducted at temperatures between about 5 to about 60° C. for about 1 to 4 hours.

17. The method of claim 12 wherein R¹ is a substituted C1 to C8 alkyl comprising a free radical reactive group selected from the group consisting of (meth)acrylates, styryls, vinyls, vinyl ethers, C₁₋₆alkylacrylates, acrylamides, C₁₋₆alkylacrylamides, N-vinyllactams, N-vinylamides, C₂₋₁₂alkenyls, C₂₋₁₂alkenylphenyls, C₂₋₁₂alkenylnaphthyls, or C₂₋₆alkenylphenylC₁₋₆alkyls.

18. The method of claim 17 wherein the free radical reactive group is selected from the group consisting of (meth)acrylates, acryloxys and (meth)acrylamides.

19. The method of claim 12 wherein R¹ is H, reacting step (b) forms a silane terminated polydimethylsiloxane and said method further comprises the step of
(c) reacting said silane terminated polydimethylsiloxane with a molar excess of allyl(meth)acrylate or substituted epoxide in the presence of at least one hydrosilylation catalyst.

20. The method of claim 19 wherein said hydrosilylation catalyst is Pt₂{[(CH2═CH)Me₂Si]₂O}₃ or Ashby's catalyst.

21. The method of claim 20 wherein said hydrosilylation catalyst is present in an amount between about 5 and about 500 ppm and the reaction is conducted under conditions, comprising a temperature between about 0 to about 100° C. for up to about 24 hours.

22. The method of claim 21 where reacting step (c) is conducted neat.

23. The method of claim 19 wherein said silane terminated polydimethylsiloxane is reacted with a allyl(meth)acrylate

24. The method of claim 23 wherein said allyl(meth)acrylate is selected from the group consisting of allyl(meth)acrylate, allyloxyhydroxypropyl methacrylate and allyloxyhydroxypropylacrylate.

25. The method of claim 23 wherein said allyl(meth)acrylate is allyloxyhydroxypropyl methacrylate or allyloxyhydroxypropylacrylate.

26. The method of claim 19 wherein said silane terminated polydimethylsiloxane is reacted with a substituted epoxide of epoxides of formula III 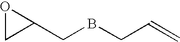
where B is a group which can hydrogen bond with another moiety or a carboxylic acid derivative.

27. The method of claim 29 wherein B is selected from the group consisting of heteroatoms, carbonyl, alkylene having 1 to 6 carbon atoms which may be unsubstituted or substituted with hydroxy, amines, amides, ethers, esters, aldehydes, ketones, aromatics, alkyl groups and combinations thereof.

28. The method of claim 29 wherein B is 0 or a hydroxyl substituted alkyl group having 1-4 carbon atoms.

29. The method of claim 29 wherein said substituted epoxide is allyl glycidyl ether.

30. The method of claim 19 further comprising the step of purifying said silane terminated polydimethylsiloxane prior to reaction step (c).

31. The method of claim 30 wherein said purifying step comprises evaporating chlorosilane remaining after step (b) followed by aqueous extraction using aqueous base and distillation.

32. The method of claim 12 wherein said organometallic compound is an alkyl lithium compound of the formula RLi wherein R is an alkyl group of 1-8 carbon atoms.

33. The method of claim 30 wherein said purifying step comprises fractionating the said silane terminated polydimethylsiloxane to form a monodisperse or narrow disperse silane terminated polydimethylsiloxane.
The method of claim 23 wherein the product of reacting step (c) is a free radical reactive, substituted or unsubstituted alkyl-terminated polydimethylsiloxanes, and said process further comprises the step of
(d) fractionating the free radical reactive, substituted or unsubstituted alkyl-terminated polydimethylsiloxane to form a monodisperse or narrow disperse free radical reactive, substituted or unsubstituted alkyl-terminated polydimethylsiloxane.

34. The method of claim 1 wherein said reacting step is conducted in a non-polar solvent.
